(19) United States
(12) Patent Application Publication
(10) Pub. No.: US 2016/0180299 A1
(43) Pub. Date: Jun. 23, 2016

(54) PAYMENT UNIFICATION SERVICE

(71) Applicant: HEWLETT PACKARD ENTERPRISE DEVELOPMENT LP, Houston, TX (US)

(72) Inventor: Dominique Sandraz, Sunnyvale, CA (US)

(21) Appl. No.: 14/909,480

(22) PCT Filed: Aug. 20, 2013
(86) PCT No.: PCT/US2013/055693

§ 371 Date: Feb. 2, 2016

(51) Int. Cl. G06Q 20/02; G06Q 20/40

(52) U.S. Cl. CPC G06Q 20/027; G06Q 20/401

(57) ABSTRACT

Example embodiments relate to a payment unification service. In some examples, a system may include a gateway interface to communicate with multiple unification gateways respectively associated with multiple payment services. Each unification gateway may allow the associated payment service to transact with other of the payment services via their associated unification gateways. The system may include a gateway directory to store a list of trusted unification gateways. The gateway directory may receive a gateway lookup request from a first unification gateway associated with a first payment service when a transaction is to be initiated between the first payment service and a second payment service via their associated unification gateways. The gateway directory may return gateway connection information to the first unification gateway in response to the gateway lookup requests to allow the transaction to proceed.

### BACKGROUND

Sellers (e.g., online merchants) are often able to sell goods or services (e.g., intangible goods such as electronic documents) for a very small price due to little or no cost of producing those goods or services. These transactions of a very small price may be referred to as “micro-transactions,” and may range in price, for example, from a couple of dollars down to one cent ($0.01). Such sellers may depend on a very large number of transactions to make a profit. Various sellers (e.g., online merchants) may be unable to accept cash for payment, and they may rely instead on various other payment methods to process transactions (e.g., credit cards, debit cards, etc.).

Various online users (e.g., buyers and sellers) may use various payment services (e.g., Paypal) to make the process of paying for goods and services online easier and more secure. Such payments services may allow a user, after the user registers with the service, to store payment information (e.g., credit card information), and then the user may transfer money to other users of the same payment service.

### BRIEF DESCRIPTION OF THE DRAWINGS

The following detailed description references the drawings, wherein:

FIG. 1 is a block diagram of an example network setup where a payment unification service may be used in such a setup;

FIG. 2A is a flowchart of example method for a payment unification service;

FIG. 2B is a flowchart of example method for a payment unification service;

FIG. 3A is a block diagram of an example unification gateway to facilitate a payment unification service;

FIG. 3B is a block diagram of an example unification gateway to facilitate a payment unification service;

FIG. 4 is a flowchart of an example method for a payment unification service;

FIG. 5 is a block diagram of an example payment unification system;

FIG. 6 is a flowchart of an example method for payment unification; and

FIG. 7 is a flowchart of an example method for payment unification.

### DETAILED DESCRIPTION

As mentioned above, various sellers (e.g., online merchants) may be unable to accept cash for payment, and they may rely instead on various other payment methods to process transactions (e.g., credit cards, debit cards, etc.). The financial infrastructure to process transactions with credit cards and debit cards is designed to process larger payments, e.g., large compared to the micro-transactions described above. The cost (e.g., fees) to process very small transactions using traditional solutions, like credit cards, may be higher than the transaction amount itself, making such solutions economically not viable. As a consequence sellers may be unable to implement a business model that depends on very small prices and a high volume of transactions. Also mentioned above, various online users (e.g., buyers and sellers) may use various payment services (e.g., Paypal) to make the process of paying for goods and services online easier and more secure. In general, such payment services are still designed to process larger payments, and the cost (e.g., fees) may still make micro-transactions not viable.

Some payment services have introduced solutions to lower transaction fees for smaller transactions. These payment services may reduce the cost of processing smaller transactions, but such services may still charge fees that are too high to implement a business model that relies on transactions that are very small (e.g., below 20 cents) and a very high volume of transactions. Such services have been unable to allow a “critical mass” (e.g., billions instead of millions) of buyers to participate in order realize enough transaction volume to make such a business model viable. For example, many buyers may be dissuaded from participating because they do not want to go through the hassle of registering for the same payment service used by the seller. Buyers may, for example, dislike using multiple payment services to interact with multiple sellers. Not only may the buyers need to register for each of these payment services, but they may also need to share their financial information (e.g., credit cards, bank account information, etc.) with each service. These hassles of registering for and setting up multiple payment services may act as a barrier that limits the number of buyers that may participate in a seller's micro-transaction business.

The present disclosure describes a payment unification service that allows users (e.g., buyers and sellers) to easily transact with each other even if the users are registered with different payment services. Each payment service may install, run, connect to and/or support a unification gateway. The payment unification service may communicate (via the unification gateways) with multiple payment services. The payment unification service and the unification gateways may allow the multiple payment services to transact with each other. The payment unification service may include a gateway directory to store a list of trusted unification gateways. A first unification gateway, for example, may request gateway connection information for a second unification gateway by issuing a gateway lookup to the payment unification service and the gateway directory. The first unification gateway may then use the gateway connection information to transact with the second unification gateway. This solution allows buyers and sellers to remain anonymous or semi-anonymous vis-a-vis each other. For example, a buyer need not establish a relationship with the seller or the seller's payment service. User's (e.g., buyers and sellers) need only establish a relationship with their preferred payment service. This solution may leverage the existing banking/billing information that users have provided to their preferred payments service. And, this solution may not require users to share their banking/billing information with several other payment services. Because users (e.g., buyers) need not register with a new payment service simply to transact with a seller, the registration barriers between buyers and sellers of previous payment systems are reduced or eliminated. Thus, sellers with micro-payment business models may be able to reach a critical mass of buyers.

The present disclosure also describes aggregation of authorized transactions (e.g., into a single money transfer) and aggregation of payment and billing to users. This may allow for several micro transactions to take place without fees actually being imposed (e.g., fees are deferred). Then, when several authorized transactions have taken place, an actual money transfer may occur. The fee for the actual money transfer may be distributed across the authorized transactions, which may allow for a very low average per-transaction fee. Thus, micro transactions may be viable because of the aggregation of authorized transactions and the levering of existing banking/billing information of buyers and sellers. It should be understood that the solutions described herein may also be used for larger transactions, and thus, the descriptions provided herein are not limited to micro-transactions. The present disclosure also describes sharing of revenue or profit between participants of the payment unification service (e.g., payment services and the payment unification service itself). Shared revenue may offer an incentive to payment services to offer buyers and sellers the best experience.

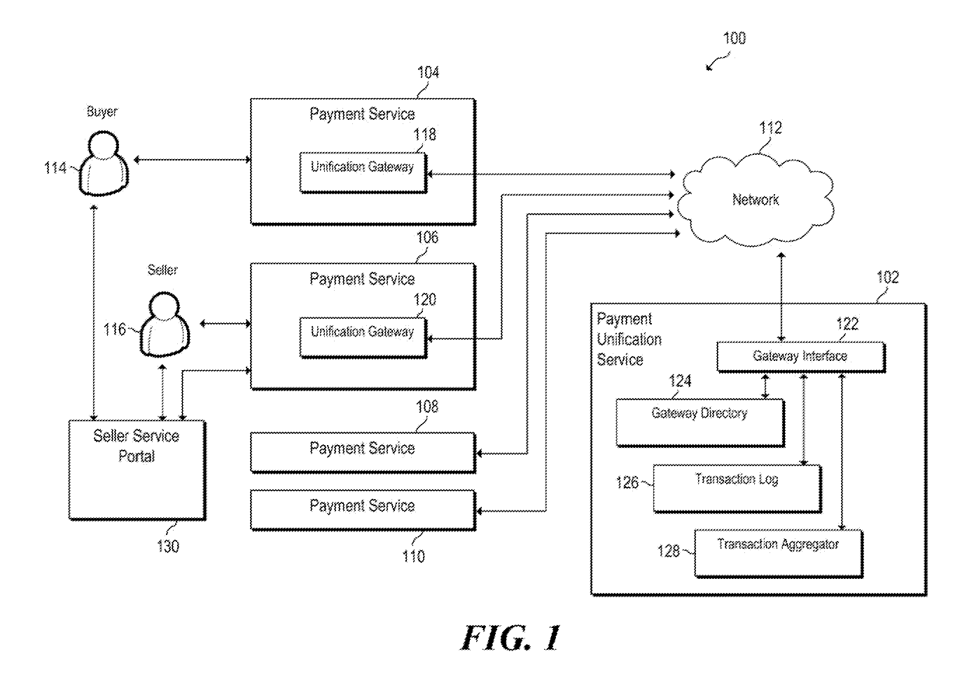

FIG. 1 is a block diagram of an example network setup 100 where a payment unification service may be used in such a setup. Network setup 100 may include a payment unification service 102, as described in more detail below. Network setup 100 may include a number of payment services (e.g., 104, 106, 108, 110), each being in communication with payment unification service 102, for example, via at least one network (e.g., 112). Network 112 may be any wired and/or wireless network, and may include any number of hubs, routers, switches or the like. Network 112 may be, for example, part of the internet, at least one intranet and/or other type(s) of network(s). In some examples, different payment services may communicate with payment unification service via different networks, even though FIG. 1 shows the payment services being connected via the same network 112.

Each payment service (e.g., 104, 106, 108, 110) may allow users (e.g., buyers and/or sellers) to communicate (e.g., via the Internet or some other network and a web browser or application) with the payment service. For example, buyer 114 may communicate with payment service 104 and seller 116 may communicate with payment service 106. Various example payment services may allow just buyers or just sellers or buyers and sellers to establish accounts and use such a payment service to send and/or receive money (e.g., digital representations of money). The term “buyer” may refer to an individual or organization that is connected to a seller service portal (e.g., 130) to purchase a product or service (e.g., a streaming video). The term “seller” may refer to an individual or organization that connects to a seller service portal (e.g., 130) to provide a product or service.

Each payment service (e.g., 104, 106, 108, 110) may be implemented as at least one computing device, for example, any computing device accessible to users (e.g., buyers and/or sellers) over the Internet or some other network. In some examples, at least one of the payment services may be implemented as more than one computing device, for example, computing devices that are in communication with each other (e.g., via a network). In these examples, the computing devices may operate together and provide a coordinated service to users. In these examples, the computing devices may be separate devices, perhaps geographically separate. The terms “system” and “service” may be used to refer to a computing environment that includes one computing device or more than one computing device.

Each payment service (e.g., 104, 106, 108, 110) may include a unification gateway (e.g., 118, 120). Payment services 108 and 110 may each include a unification gateway even though such gateways are not shown in FIG. 1. In order for a payment service to benefit from the payment unification service 102, the payment service may need to install, run, connect to and/or support a unification gateway. Unification gateways (e.g., 118, 120) may be, for example, designed and provided by the same organization that maintains payment unification service 102. Such an organization may provide or publish unification gateways (e.g., as HTML, JavaScript or other code), and then payment services may install or run such a unification gateway as part of the payment service. In order to install or run such a unification gateway, the payment service may link various aspects of the unification gateway (e.g., an account manager) to related aspect of the payment service (e.g., user accounts) to allow for proper communication. In some examples, at least one payment service (e.g., 104, 106, 108, 110) may be hosted or run by the same organization that maintains payment unification service 102, in which case, the organization may add a payment gateway to the payment service. Unification gateways may be described in more detail below. In some examples, at least one unification gateway may be implemented partially on the payment service side and partially on the payment unification service side (e.g., with portions of code running on each side).

Payment unification service 102 may be implemented as at least one computing device, for example, any computing device accessible to payment services (e.g., 104, 106, 108, 110) over the Internet or some other network (e.g., 112). In some examples, payment unification service 102 may be implemented as more than one computing device, for example, computing devices that are in communication with each other (e.g., via a network). In these examples, the computing devices may operate together and provide a coordinated service. In these examples, the computing devices may be separate devices, perhaps geographically separate. The terms “system” and “service” may be used to refer to a computing environment that includes one computing device or more than one computing device.

From an operational standpoint, a buyer (e.g., 114) may browse or view products or services provided by a seller (e.g., 116) by connecting to a service portal provided by the seller (e.g., seller service portal 130). For example, buyer 114 may connect to seller service portal 130 via the Internet or some other network and a web browser or application (e.g., via an http connection). Seller service portal 130 may, for example, host a website (e.g., a collection of webpages) and may allow users (e.g., buyers) to connect to the website to browse, view and buy products and/or services. Seller service portal 130 may be, for example, at least one computing device capable of running a web server and hosting a website. Seller service portal may allow at least one seller (e.g., 116) to connect to the portal to manage the products and/or services provided by the seller. A buyer (e.g., 114) may identify (e.g., via seller service portal 130) a product or service that the buyer desires to purchase. The buyer may initiate a purchase request via seller service portal 130, for example, by selecting a “buy” or “checkout” button on a webpage provided by seller service portal 130. Seller service portal 130 may then communicate with a payment service (e.g., 106) used by the seller (e.g., 116).

Each payment service (e.g., payment service 106 of seller 116) may allow at least one seller service portal (e.g., 130) to communicate with the payment service to indicate that the seller (e.g., 116) desires to get paid for a product and/or service. Payment service 106 may then communicate (e.g., via unification gateway 120) with payment unification service 102 to determine how to connect to the buyer's unification gateway (e.g., 118), to request payment from the payment service used by the buyer (e.g., 104). As described in more detail below, payment service 104 (e.g., via unification gateway 118), for example, with authorization from user 114, may indicate to payment service 106 that payment will be sent (e.g., eventually after aggregation) and that the transaction is authorized. Payment service 106 may then communicate with seller service portal 130 to indicate that the transaction is authorized (e.g., sending a transaction authorization), and as a result, seller service portal 130 may provide the product and/or service to buyer 114.

The above example operational description illustrates one example benefit of the present disclosure. With various payment services, in order for a buyer to transfer money to a seller, the buyer may have to register for the same payment service used by the seller. Thus, in the example described above, buyer 114 may have to register (e.g., and share financial and other sensitive information) with payment service 106, even though buyer 114 may already have an account with payment service 104. Buyer 114 may prefer using payment service 104 and may only trust payment service 104. Instead, the present disclosure describes a payment unification service 102 that allows users (e.g., buyers and sellers) to use their existing and/or preferred payment services. Buyer 114 may continue to share the buyer's sensitive information (e.g., billing information) only with the payment service that the buyer trusts. Likewise, seller 116 may use the payment service (e.g., 106) that the seller trusts. Thus, buyers and sellers need only establish a relationship with whatever single payment service the buyers/sellers trust, and buyers are not required to establish a relationship with the payment service of the seller or the seller itself.

To allow buyers and sellers to use their existing payment services, each payment service (e.g., 104 and 106) may include its own unification gateway (e.g., 118, 120). Each unification gateway (e.g., 118, 120) may allow the associated payment service to communicate with payment unification service 102. Via these unification gateways and via payment unification service 102, various payment services (e.g., 104 and 106) may conduct transactions and may transfer money between themselves on behalf of buyers and sellers (e.g., 114, 116). Such transactions and transfers may essentially be a negotiation between the gateways (e.g., 118, 120), not a direct negotiation between the buyer (e.g., buyer's account) and the seller (e.g., seller's account). Buyers and sellers may be authenticated by the particular payment service (and perhaps the unification gateway) used by the buyer or seller. Thus, a buyer may not need to be authenticated by the payment service or unification gateway of the seller, and vice versa. Buyers and sellers (and/or their payment services) may trust the payment unification service, for example, to only allow other reputable and trustworthy payment services to participate in the payment unification service. Thus, buyers and sellers (and/or their payment services) may not need to directly trust or authenticate each other.

Payment unification service 102 may include a gateway interface 122, a gateway directory 124, a transaction log 126 and a transaction aggregator 128. Gateway interface 122 may allow payment unification service 102 to communicate with multiple unification gateways (e.g., 118, 120) respectively associated with multiple payment services (e.g., 104, 106, 108, 110). Gateway interface 122 may, for example, receive gateway lookup requests from unifications gateways. Gateway interface 122 may then communicate with gateway directory 124 to perform such a gateway lookup and may return lookup results to the requesting unification gateways. Gateway interface 122 may also receive transaction and/or transfer information (e.g., transaction identifier, money amounts, involved gateways, timestamps, etc.) related to transactions and/or transfers that take place between various unification gateways. Gateway interface 122 may then communicate such transaction and/or transfer information to transaction log 126 and/or transaction aggregator 128. Gateway interface 122 may also send transaction aggregation information from transaction aggregator 128 to various unification gateways.

Gateway directory 124 may maintain a list of trusted gateways. Each unification gateway (e.g., 118, 120, etc.) that is provided (e.g., to various payment services) by payment unification service 120 may have an associated gateway identifier (e.g., numbers and/or letters). Each unification gateway may also be associated with particular gateway connection information (e.g., URL, network address, etc.) that allows other unification gateways to connect to the unification gateway. Thus, gateway directory 124 may maintain a list of gateway identifiers and/or gateway connection information for trusted gateways. Each unification gateway may be associated with a particular payment service. Gateway directory 124 may store which payment service is associated with each payment gateway; however, it may be unnecessary to store the payment services associated with the gateways. For example, payment unification service may treat each payment service as a black box, and may not care about precisely how the payment service works as long as the payment service includes and/or supports a unification gateway.

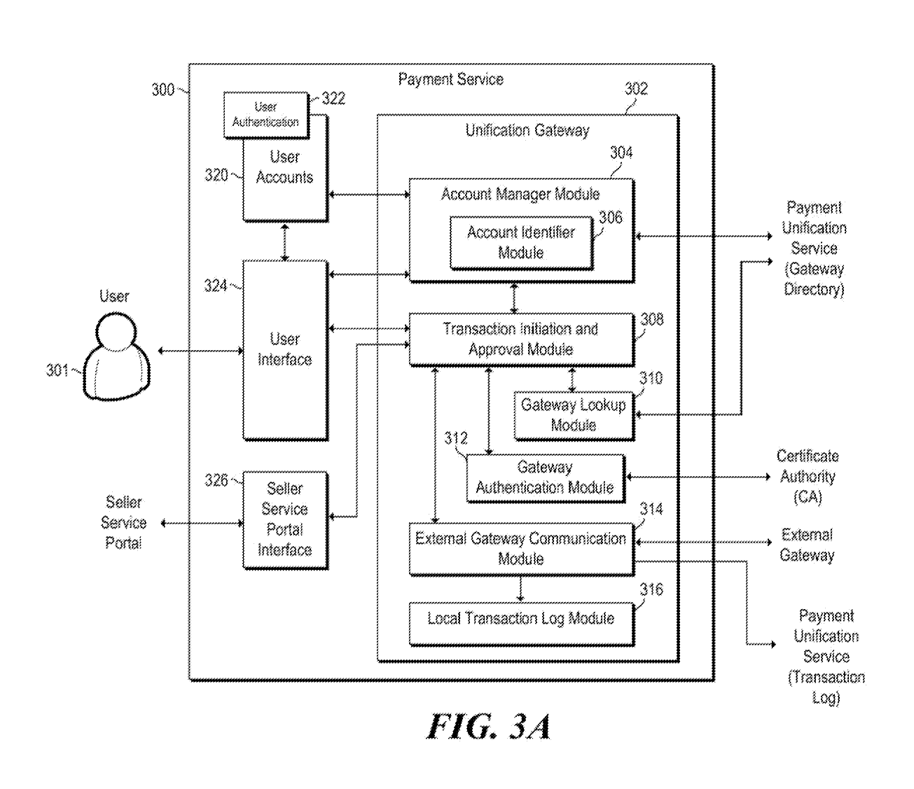

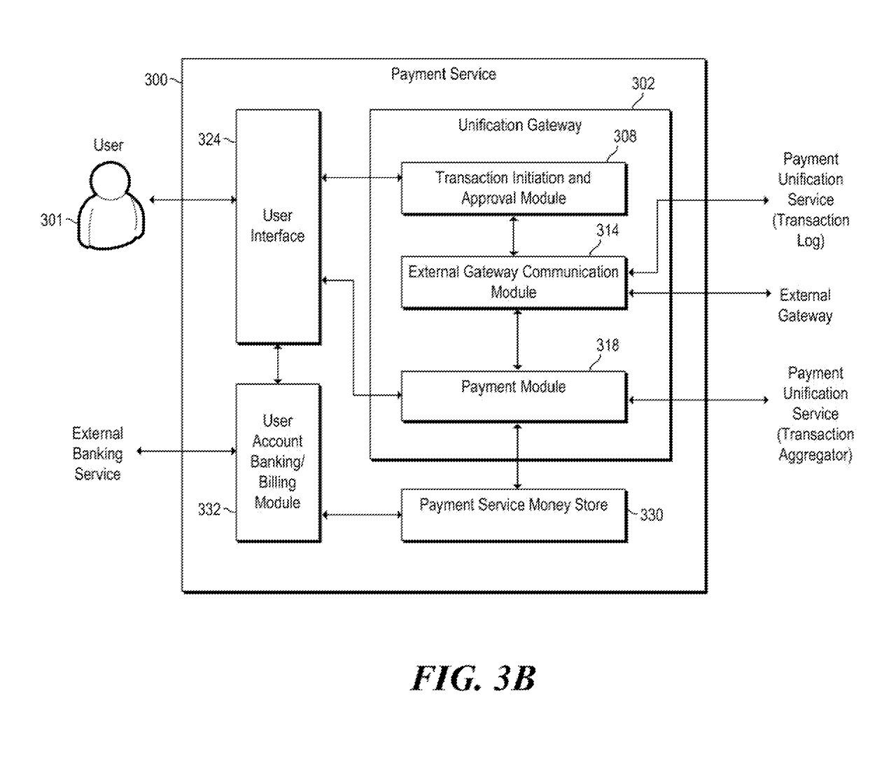

Gateway directory 124 may maintain a list of users (e.g., buyers and/or sellers). Users may be indicated in the gateway directory 124 by a user identifier (e.g., an email address, phone number, account number, temporary account number, etc.). The term “buyer identifier” may be a more general term that may cover either a buyer identifier or a seller identifier. Each user identifier in the gateway directory 124 may be unique, in which case, each user identifier may uniquely identify a particular user (e.g., buyer 114). User identifiers may identify users regardless of the payment service that the users are associated with. Thus, if a particular user has accounts with multiple payment services, care may be taken to ensure that each unique user may be associated with a particular unification gateway (e.g., and payment service). For example, if a user registers with two payment services, using the same email address as an identifying piece of information, then that email address alone may not, at least alone, serve as a useful user identifier in gateway directory 124. In such a case, a different user identifier may be used, or an additional piece of user identification information may be stored in gateway directory 124. In one particular example, when a user is registered with or introduced to the payment unification service 102, a unique user identifier may have to be provided. During such registration or introduction, gateway directory 124 may check that such a user identifier is not already in use. If it is, a different user identifier may have to be provided in order to register or introduce the user. The decision of which user identifier is used for a particular user may be made by the user or automatically on the user's behalf (e.g., by the payment service or the unification gateway). As may be described in more detail below, the user may later use the user identifier to make purchases (e.g., via seller service portal 130). More information about user identifiers may be described below with regard to account manager module 304 of FIG. 3A, which may describe how users are registered with, introduced to and/or tracked in the payment unification service 102.

Gateway directory 124 may maintain, for each unique user identifier, an associated gateway (e.g., gateway identifier, gateway connection information, etc.), which may be associated with the payment service used by the user. In other words, gateway directory 124 may maintain a number of user identifier/gateway pairs. Each particular pair may only be maintained by the gateway directory 124 if the gateway is trusted, e.g., in the list of trusted gateways. Gateway directory 124 may perform gateway lookups. Gateway directory 124 may receive gateway lookup requests from gateway interface 122, which were in turn received from various unification gateways. A gateway lookup request may include a user identifier (e.g., email address, phone number, account number, temporary account number, etc.), for example, the user identifier of the buyer (e.g., 114) requesting a product or service. Gateway directory 124 may then determine the gateway (e.g., gateway identifier, gateway connection information, etc.) associated with the user identifier, and may return the gateway to the gateway interface 122, to in turn be returned to the requesting unification gateway. The requesting unification gateway may then use the returned information to connect to the unification gateway.

Transaction log 126 may maintain a record of transactions and/or transfers of money that occur between various unifications gateways (e.g., 118 and 120). Transaction log 126 may receive transaction and/or transfer information from gateway interface 122, and may store such information in a central location. Transaction and/or transfer information may include pieces of data such as type of transaction, description of the transaction, transaction identifiers, transaction requests and approvals, user identifiers for involved users, money amounts, involved gateways (e.g., gateway identifiers or gateway connection information), timestamps (e.g., date and time), device identifiers and the like. A transaction identifier may be provided by a gateway involved in a transaction, and may be temporary, as described in more detail below. Transaction and/or transfer information may not include any personal information of involved users (e.g., buyers and/or sellers). Thus, transaction log 126 maintains a semi-anonymous record of transactions. Such stored information may be used by the payment unification service to, for example, check whether various transactions are pending or have completed. Such stored information may also be used as a record of transactions and transfers in the case of litigation. More information about transaction information provided by unification gateways may be described below with regard to external gateway communication module 314 of FIGS. 3A and 3B.

Transaction aggregator 128 may allow for several small (i.e., micro) authorized transactions to be aggregated into a single money transfer between unification gateways. By using transaction aggregator 128, payment unification service 102 may allow various small transactions to be authorized, while refraining from indicating that a money transfer should take place between the involved unification gateways. When a transaction is authorized, payment services (e.g., 104, 106) may allow the buyer (e.g., 114) to receive the product or service offered by the seller (e.g., 116); however, money may not actually transfer from the buyer's payment service to the seller's payment service. When transaction aggregator 128 determines that a money transfer should occur, money may actually transfer from the buyer's payment service to the seller's payment service. More particularly, when a number of small transactions have been authorized (e.g., between two particular payment services), transaction aggregator 128 may indicate that a money transfer should occur (e.g., between the same two payment services), where the money transfer amount may essentially be the sum of the small transaction amounts. Because, for many payment services, fees are only imposed when money is actually transferred, this aggregation of transactions reduces the average cost for small transactions. The seller's payment service may not actually get paid until a money transfer occurs; however, payment services may know that money for authorized transactions is owed/promised to them, and payment services may trust (e.g., trust payment unification service and other participating payment services) that payment will come eventually.

It should be understood that various transactions (e.g., between two particular payment services) may be aggregated (e.g., into a single money transfer), even if the transactions are between various users (i.e., not always between the same seller and buyer). Instead, in order to be aggregated, transactions may only need to occur between the same payment services (e.g., between the same unification gateways). It may be the case that the payment unification service described herein may be used with payment services that experience a high volume of transactions consistently over time. Thus, it may be expected that any two of the participating payment services (e.g., unification gateways) will communicate frequently such that transaction aggregation can occur.

Transaction aggregator 128 may keep track of transaction aggregations for various payment service pairs. For example, for payment services 104 and 106, transaction aggregator 128 may keep track of a dollar amount of aggregated transactions that have occurred since the last time a money transfer occurred between the same two payment services. While the aggregated dollar amount is below a defined threshold, transaction aggregator 128 may simply indicate that transactions between payment services 104 and 106 should be authorized. When the aggregated dollar amount reaches the defined threshold, transaction aggregator 128 may indicate that a money transfer should occur between the payment services, where the transfer amount may essentially be the sum of the aggregated authorized transaction amounts. As another example, transaction aggregator 128 may indicate that a money transfer should occur between the payment services once per each defined period of time (e.g., every week, month, etc.). The defined threshold and/or the defined period of time may be set in various ways. For example, the threshold/period may be configured by a system administrator of the payment unification service. The defined threshold/period may be determined based on various factors, for example, an agreement between various participating payment services.

Payment to sellers and billing of buyers may be aggregated in a similar manner to how transactions may be aggregated (as described above). This may reduce any transactions fees imposed between users' external banking systems and users' payment services. More details about aggregation of payment and billing may be described in more detail below.

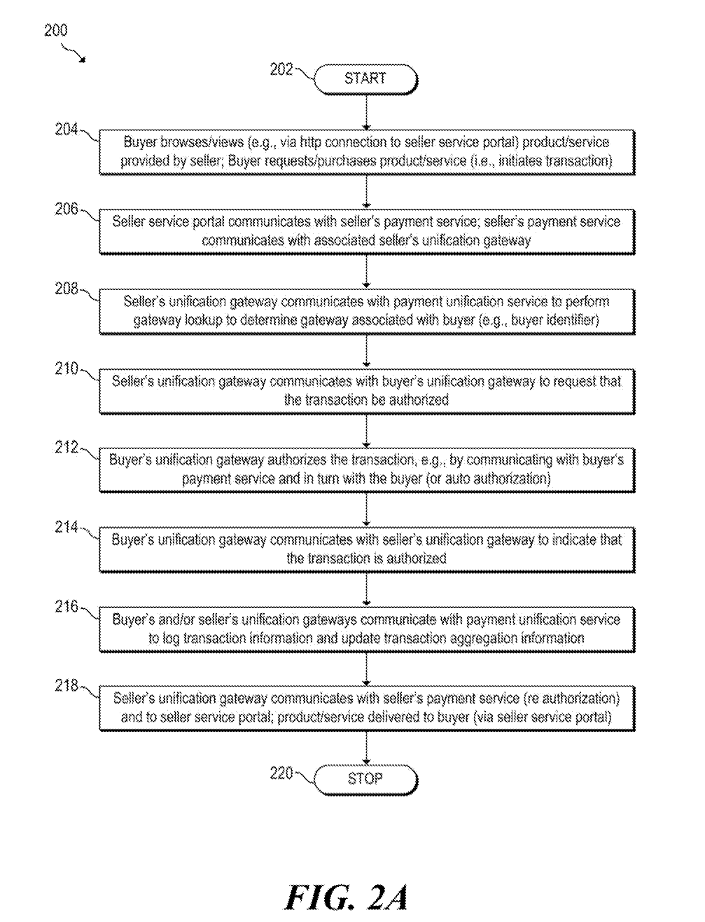

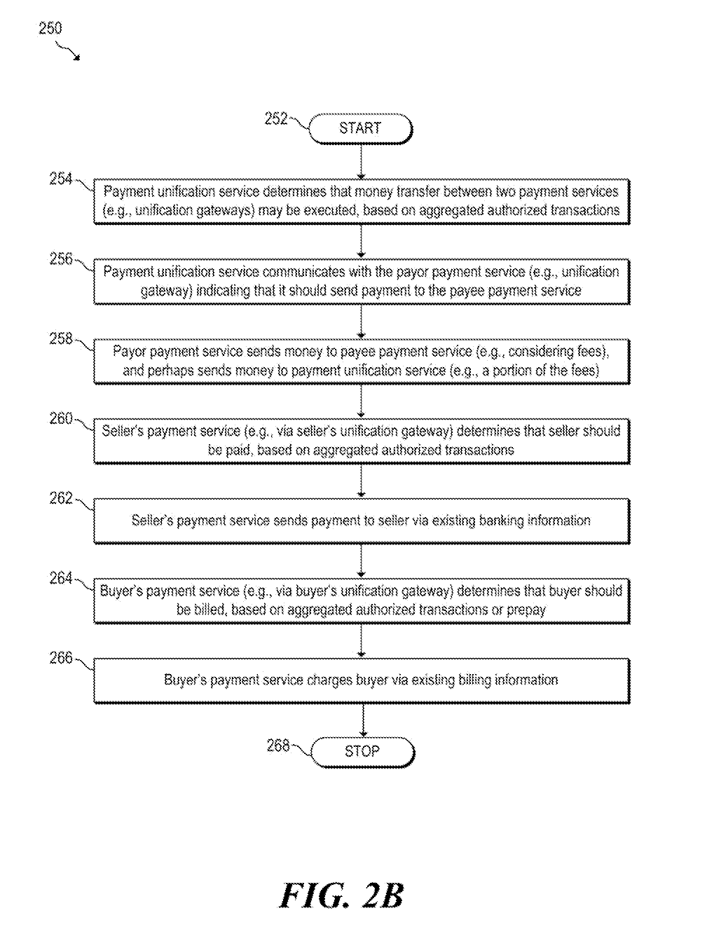

FIGS. 2A and 28 depict flowcharts of example methods 200, 250 for a payment unification service. Various steps of methods 200, 250 may be executed in various places, for example, in the seller's payment service, in the seller's unification gateway, in the buyer's payment service, in the buyer's unification gateway, and/or in the payment unification service. The steps of methods 200, 250 may be implemented in the form of executable instructions stored on at least one machine-readable storage medium. In addition or as an alternative, the steps of methods 200, 250 may be implemented using at least one hardware device that includes electronic circuitry for implementing the functionality described below. In alternate embodiments of the present disclosure, one or more steps of methods 200, 250 may be executed substantially concurrently or in a different order than shown in FIGS. 2A and 28. In alternate embodiments of the present disclosure, methods 200, 250 may include more or less steps than are shown in FIGS. 2A and 28. In some embodiments, one or more of the steps of methods 200, 250 may, at certain times, be ongoing and/or may repeat.

Method 200 may start at step 202 and continue to step 204, where a buyer (e.g., 114) may browse/view (e.g., via an http connection to seller service portal 130 of FIG. 1) a product or service provided by a seller (e.g., 116). The buyer may purchase (e.g., request that a purchase be executed) the product or service. This may initiate a transaction between the buyer and the seller. At step 206, the seller service portal (e.g., 130) may communicate with the seller's payment service (e.g., 106), which in turn may communicate with an associated unification gateway (e.g., 120). At step 208, the seller's unification gateway may communicate with a payment unification service (e.g., 102) to perform a gateway lookup to determine a unification gateway associated with the buyer. The gateway lookup may include a user/buyer identifier provided by the buyer when the buyer requested that the purchase be executed. Alternatively, the seller's unification gateway may have the buyer's unification gateway stored in a local cache. The gateway lookup (or cache lookup) may return gateway connection information for the buyer's unification gateway. At step 210, the seller's unification gateway may communicate with the buyer's unification gateway (e.g., 118) to request that the transaction be authorized. This transaction request is performed between the unification gateways, and does not require the buyer to establish a relationship with the seller or the seller's payment service.

At step 212, the buyer's unification gateway (e.g., 118) may authorize the transaction, for example, by communicating with the buyer's payment service (e.g., 104) and in turn with the buyer (to receive approval), or by automatic authorization (e.g., according to settings and/or policies). At step 214, the buyer's unification gateway may communicate with the seller's unification gateway to indicate that the transaction is authorized (e.g., referred to as an authorization response). At step 216, the buyer's and/or seller's unification gateways may communicate with the payment unification service to log transaction information and/or to update transaction aggregation information. It should be understood that logging may be performed at various points throughout method 200, and this is just one example logging step. At step 218, the seller's unification gateway communicates with the seller's payment service (regarding the authorized transaction) and in turn to the seller service portal. Then, via the seller service portal, the product or service may be delivered or provided to the buyer. Method 200 may eventually continue to step 220, where method 200 may stop.

Method 250 may start at step 252 and continue to step 254, where the payment unification service (e.g., 102) determines that a money transfer between two payment services (e.g., unification gateways) may be executed. The money transfer may be based on aggregated authorized transactions, as describe in detail above. The payment service (e.g., 104) that owes the money may be the payor payment service, and the payment service (e.g., 106) that is owed money may be the payee payment service. At step 256, the payment unification service may communicate with the payor payment service (e.g., its unification gateway) to indicate that it should send payment to the payee payment service. At step 258, the payor payment service may send money to the payee payment service. Such a money transfer may consider fees due. Payor payment service may also send money to the payment unification service (e.g., if the service receive a share of the profit).

At step 260, the seller's payment service (e.g., via the seller's unification gateway) may determine that the seller should be paid, for example, based on aggregated authorized transactions. At step 262, the seller's payment service may send payment to the seller, for example, via existing banking information stored in the seller's payment service. At step 264, the buyer's payment service (e.g., via the buyer's unification gateway) may determine that the buyer should be billed, for example, based on aggregated authorized transactions. In some examples, the buyer may prepay. At step 266, the buyer's payment service may charge the buyer, for example, via exiting billing information stored in the buyer's payment service. Method 250 may eventually continue to step 268, where method 250 may stop.

FIGS. 3A and 3B depict block diagrams of an example unification gateway 302 to facilitate a payment unification service. Unification gateway 302 may be similar to unification gateways 118 and 120 of FIG. 1, for example. FIGS. 3A and 3B may be viewed together, and thus, unification gateway 302 may include any combination of the modules shown in FIG. 3A and/or 3B. In some examples, unification gateway 302 may include more or less modules than those shown in FIGS. 3A and 3B. As depicted in FIGS. 3A and 3B, unification gateway 302 may include a number of modules, for example, modules 304, 306, 308, 310, 312, 314, 316, 318. These modules may include a series of instructions encoded on a machine-readable storage medium and executable by at least one processor accessible by payment service 300. In addition or as an alternative, these modules may include one or more hardware devices including electronic circuitry for implementing the functionality described below.

FIGS. 3A and 3B depict unification gateway 302 as being implemented in a payment service 300; however, it should be understood that in other examples, unification gateway 302 may be partially implemented in a payment service and partially implemented in the payment unification service (e.g., 102). FIGS. 3A and 3B depict unification gateway 302 as being a general purpose unification gateway that may be used for buyers and/or sellers. In the situation of unification gateway 302 being used by a buyer, various modules of unification gateway 302 may or may not be used, and various modules may operate differently than if unification gateway 302 was being used by a seller. For a buyer, unification gateway 302 may manage transactions on behalf of the buyer. For a seller, unification gateway 302 may manage transaction on behalf of the seller. In some examples, unification gateway 302 may be customized to work for a buyer only or a seller only, in which case various modules may be removed and/or various modules may operate with reduced functionality. Unification gateway 302 may also manage various aspects of transferring money between payment services, as described in more detail below.

Account manager module 304 may identify various users (e.g., user 301) that have accounts with the payment service 300. User 301 may be a buyer in the case of a buyer using unification gateway 302 or a seller in the case of a seller using unification gateway 302. Account manager module 304 may communicate with user accounts 320 of the payment service 300. Payment service 300 may have authenticated (e.g., via user authentication 322) the users associated with various user accounts, for example, by verifying a mailing address, email address, phone number, or by referencing a person information directory. Thus, account manager module 304 may assume that users associated with user accounts 320 are who they say they are. A user's (e.g., 301) registration with a particular payment service (e.g., 300) may be the only registration that a user may need to participate in the payment unification service described herein. A user's registration may include steps of registering or being introduced to the payment unification service, as described below, but the user need not register with another payment service. Once a user is registered with a payment service and introduced to the payment unification service, the user will not have to first-register in order to conduct a transaction with a seller that uses a different payment service.

Account manager module 304 may gather various pieces of identifying information about various users, for example, email address, telephone number, etc. These pieces of identifying information may be gathered mainly for account manager module 304 to track users, and this information may not be shared outside of unification gateway 302 (e.g., with other unification gateways). The identity of users outside of unification gateway 302 may be indicated in various ways, as described below with respect to module 306. It should be understood that, in the case of a buyer using unification gateway 302 for example, account manager module 304, and payment service 300 in general, does not store identifying information of the seller, unless the seller voluntarily establishes an account with the same payment service. Thus, unless the seller and buyer happen to register with the same payment service, no unification gateway in a transaction chain between the seller and buyer will store both the buyer's and seller's information. Thus, transaction privacy is maintained.

Account manager module 304 may communicate with a user interface 324 of payment service 300. In this respect, a user may interface with account manager module 304, for example, to modify and/or view the way that account manager module identifies the user.

Account identifier module 306 may determine user identifiers for various users, where for a particular user, the user identifier may be used to participate in a transaction. As one example, account identifier module 306 may simply use a piece of identifying information (e.g., email address, phone number, etc.) gathered from user accounts 320 to identify a user. As another example, module 306 may generate a new user identifier (e.g., numbers, letters, etc.) to further preserve the anonymity of the user. The new user identifier may be temporary and may change at various times. For example, a temporary user identifier may be issued per transaction, and/or for a defined period of time, and/or per seller (in the case of a user using unification gateway 302). Various other ways of changing the temporary user identifier may be used. The association between the temporary user identifier and the real user account may be known only to unification gateway 302. Thus, the temporary user identifier does not allow a seller, for example, to collect personal information of a buyer. In some situations, one real user account may be associated with multiple temporary identifiers.

Account identifier module 306 may allow a user to select, input and/or view (e.g., via user interface 324) the user's identifier in module 306. In this respect, the user may be able to stay appraised of the user identifier. Additionally, a user may have control over when and how the user's identifier changes. For example, if a buyer wanted to engage in a transaction with a seller that the buyer did not fully trust, the buyer may change the buyer's identifier to a random number. This may ensure full anonymity while avoiding unwanted user authorization requests. Likewise, if the buyer trusted the seller, the buyer may use a more convenient identifier, such as an email address. Account identifier module 306 may communicate with payment unification service (e.g., gateway directory 124) to ensure that the gateway directory is storing the current identifier for the user.

Account identifier module 306 may communicate with the payment unification service (e.g., whenever a user creates or changes the user's identifier) to check that the user identifier is not already stored in the gateway directory (e.g., 124). The process of account identifier module 306 creating a user identifier and checking to ensure that the identifier is not already used in the gateway directory may be referred to as registering the user with or introducing the user to the payment unification service.

A user (e.g., a buyer) may use the user's identifier when engaging in a transaction. For example, referring to FIG. 1, when buyer 114 is ready to “buy” or “checkout”, buyer 114 may provide the user's identifier (e.g., via seller service portal 130). In some examples, buyer 114 may use a web browser to access seller service portal 120, and the web browser may store or cache the buyer's current identifier and provide it to seller service portal 120. This may be the only piece of information that the buyer 114 has to provide in order to initiate the transaction, and eventually to cause payment to be sent to the seller. Once the buyer provides the user identifier, seller service portal 130 may send the identifier to payment service 106 and to unification gateway 120. Unification gateway may then use the user identifier to perform a gateway lookup, as described in more detail herein.

Referring again to FIGS. 3A and 3B, transaction initiation and approval module 308 may, when used by a seller, initiate a transaction, for example, in response to a communication from seller service portal interface 326, which may communicate with seller service portal 130 of FIG. 1, for example. The communication from seller service portal interface 326 may include a user identifier provided by a buyer. Transaction initiation and approval module 308 may send the user identifier to gateway lookup module 310 to determine a unification gateway associated with the buyer. Once module 308 receives (e.g., from module 310) the unification gateway (e.g., a URL or network address) associated with the buyer, module 308 may communicate with gateway authentication module 312 to authenticate the buyer's gateway. If the buyer's gateway is approved, module 308 may establish a connection (e.g., via module 314) with the buyer's unification gateway (e.g., shown as “external gateway” in FIG. 3A) to request authorization of the transaction (e.g., indicating that payment will be sent eventually). When module 308 receives authorization, it may communicate with seller service portal interface 326 to provide the product or service to the buyer.

Transaction initiation and approval module 308 may, when used by a buyer, receive a transaction authorization request from a seller unification gateway (e.g., via module 314). Module 308 may then determine whether to authorize the transaction. Module 308 may prompt the buyer for approval via user interface 324. In this scenario, an alert may display on a device of the buyer, e.g., the device (e.g., a desktop computer) used by the buyer to interface with the seller service portal or a separate device (e.g., a smartphone). Module 308 may then receive an approval response from the buyer and may then indicate (e.g., via module 314) that the transaction is authorized to the seller's unification gateway. In some examples, module 308 may automatically approve some or all transactions of the buyer. Automatic approval may be based on various settings and/or policies, for example, settings in user accounts 320 and/or policies established by payment service 300. Additionally, the authentication method may vary depending on various factors, for example, the type of transaction (e.g., one-time, reoccurring, duration, reserve needed, etc.), the type of user, etc. As one example, a buyer may establish settings for an automatic authorization for a particular seller for transactions that do not exceed, in total, one dollar per week. Such a setting may permit the buyer to engage in many small transactions without having to manually approve each one, and may permit the buyer to engage in frequent transactions with trusted sellers, where certain transactions (e.g., music, streaming video, etc.) happen quickly (e.g., real-time). User settings and polices may be configured to automatically authorize in various other situations.

Gateway lookup module 310 may communicate with the payment unification service (e.g., with gateway directory 124) to perform gateway lookups. For example, once module 308 provides (e.g., from seller service portal interface 326) a user identifier (e.g., an email address) provided by a buyer, gateway lookup module 310 may send this user identifier to gateway directory 124, and in return may receive from gateway directory 124 a gateway (e.g., a URL or network address) associated with the buyer. Module 310 may then provide the gateway information to module 308. In some examples, unification gateway 302 (e.g., via module 310) may store or cache user identifier/gateway pairs, for example, for common users, important users, etc. In these examples, if module 310 has a hit in its cache, module 310 may not need to contact gateway directory 124. In some examples, the buyer and the seller may both use the same payment service, in which case seller service portal interface 326 and/or module 310 may detect such a scenario and may determine the buyer's gateway without contacting gateway directory 124.

Gateway authentication module 312 may authenticate gateways, e.g., based on gateway URL's or network addresses provided by gateway lookup module 310. Each unification gateway that participates in the payment unification system described herein may request and receive a digital certificate, e.g., from a certificate authority (CA). Other unification gateways may then confirm the identity of a particular gateway, for example, by communicating with the CA to check the digital certificate. Essentially, the check ensures that the gateway is who it claims to be. As one example, when a seller is using unification gateway 302, it may receive (e.g., from module 310) gateway information associated with a buyer. Then, module 312 may communicate with a CA to confirm that the gateway information is legitimate (e.g., that the certificate of the buyer's gateway is valid). In some situations, a buyer's unification gateway, may confirm the identity of a seller's unification gateway, for example, when the seller's unification gateway requests a transaction approval.

External gateway communication module 314 may generally be used to communicate with other unification gateways. For example, in the case of a seller using unification gateway 302, module 314 may send transaction authorization requests to buyer unification gateways and receive transaction authorizations. Additionally in the case of a seller, module 302 may receive money transfers from buyer unification gateways. In the case of a buyer using unification gateway 302, module 314 may receive transaction authorization requests from seller unification gateways and send transaction authorizations. Additionally in the case of a buyer, module 302 may send money transfers to seller unification gateways.

Local transaction log module 316 may maintain a local record of transactions and/or transfers of money that occur between unification gateway 302 and various other unifications gateways. Local transaction log module 316 may operate and store information in a similar manner to transaction log 126, except that local transaction log module 316 may only store information from the perspective of unification gateway 302. Module 302 may not receive transaction information (for logging purposes) from any other unification gateways. By contract, transaction log 126 may receive transaction information from both parties to a transaction (e.g., from the buyer's unification gateway and the seller's unification gateway).

Payment module 318 may communicate with payment unification service (e.g., transaction aggregator 128) to receive indications of when money transfers should be made to other unification gateways. Payment module 318 may also handle money transfers sent from other unification gateways. As described above, transaction aggregator 128 may aggregate multiple authorized transactions and then may indicate to a particular unification gateway that it should transfer money to another payment gateway. In general, the term “payor” or “payor unification gateway” may be used to refer to a unification gateway that owes money to another unification gateway. Likewise, the term “payee” or “payee unification gateway” may be used to refer to a unification gateway that is owed money by another unification gateway.

If unification gateway 302 receives an indication that it should transfer money, module 318 may communicate with payment service money store 330 to access the money. Payment service money store 330 may generally represent a repository of payment service 300 that stores money (e.g., digital representations of money) owned by the payment service. In other words, payment service money store 330 may store the general wealth of the payment service 300. The wealth may be made up of money deposited and received by various users of the payment service. Once payment module 318 accesses the money to be transferred, module 318 may communicate with module 314 to transfer the money, and the amount of money transferred may be debited from payment service money store 330. If unification gateway 302 is owed money, it may receive money via module 314, and then the money may be sent to payment module 318, and in turn to payment service money store 330, in which case money may be credited to store 330.

Payment module 318 may handle aggregation of payments to sellers and billings of buyers as well. Payment module 318 may, in the case of a buyer using unification gateway 302, track money owed by various buyers. Even though a buyer may owe money to the payment service, payment module 318 may cause the payment service to refrain from billing the buyer. Once a defined threshold is met (e.g., a money amount or a time period) for the user, payment module 318 may cause the payment system to bill the buyer, for example, using user account banking/billing information already stored by the payment service (e.g., in module 332). Payment module 318 may communicate directly with module 332, or it may communicate via payment service money store. Either way, module 332 may receive money from the buyer's external banking service and transfer/credit the money to payment service money store 330. In some situations, the buyer may be billed up front, for example, to establish a credit of money in payment service 300, and that amount may be debited over time, instead of aggregated billing.

In the case of a seller, payment module 318 may aggregate payments in a similar manner to billings. Once the amount owed to a particular seller reaches a defined threshold, module 318 may cause (e.g., via store 330) module 332 to send money to the seller's external banking service. Alternatively, payments may be made to sellers at defined intervals (e.g., each week, month, etc.). In some situations, sellers may be able to configure preferences regard the defined interval. In some situations, a seller may, for example, be able to get paid more frequently if the seller is willing to pay a high fee. Sellers may not actually be paid until a money transfer is actually executed. This means that sellers may deliver products and services based on authorized transactions without actually being paid. However, sellers may know that money for authorized transactions is owed/promised to them, and they may trust that they will get paid in the future.

The payment unification service described herein may allow for flexibility in fees. Various other payment services may charge a fixed fee for transactions, which is at least one reason why micro transactions are not feasible with such services. Because the current solution allows for flexibility in when money is transferred, the solution also allows for flexibility regarding the average fee per transaction. For example, if 100 transactions are authorized between two unification gateways before money is actually transferred, the average fee per transaction may be 1/100^{th} of fees incurred using other services. In theory, the per-transaction fee may be lowered as much as desired as long as enough transactions can be aggregated in an acceptable amount of time before a money transfer occurs.

The payment unification service may also allow for flexibility in revenue sharing between involved parties. For example, in a typical transaction between a buyer and a seller, the buyer and/or the seller may pay or owe a fee. Fees may be aggregated in a manner similar to how billings, payments and authorized transactions are aggregated. For example, for a seller, if the seller owes any fees, these fees may be aggregated for all the seller's transactions (e.g., for a time), and then the fees may be subtracted from the amount owed to the seller before the seller is paid. A similar situation may exist for the buyer.

These fees paid by the buyers and/or sellers (minus any lost costs/fees required to transfer money from one payment service to another) create a profit pool by which parties involved in the payment unification service can make a profit. Typical parties to a transaction, according to this disclosure, include the buyer's payment service, the seller's payment service and the payment unification service. A division or split of profits may be determined such that each of these parties gets a percentage of the profit pool. For example, the buyer's payment service may receive 40%, the sellers payment service may receive 40%, and the payment unification service may receive 20%. The fees charges for each transaction and the division of profits between involved parties may be determined in various ways, for example, by a system administrator of the payment unification service or an agreement between the parties.

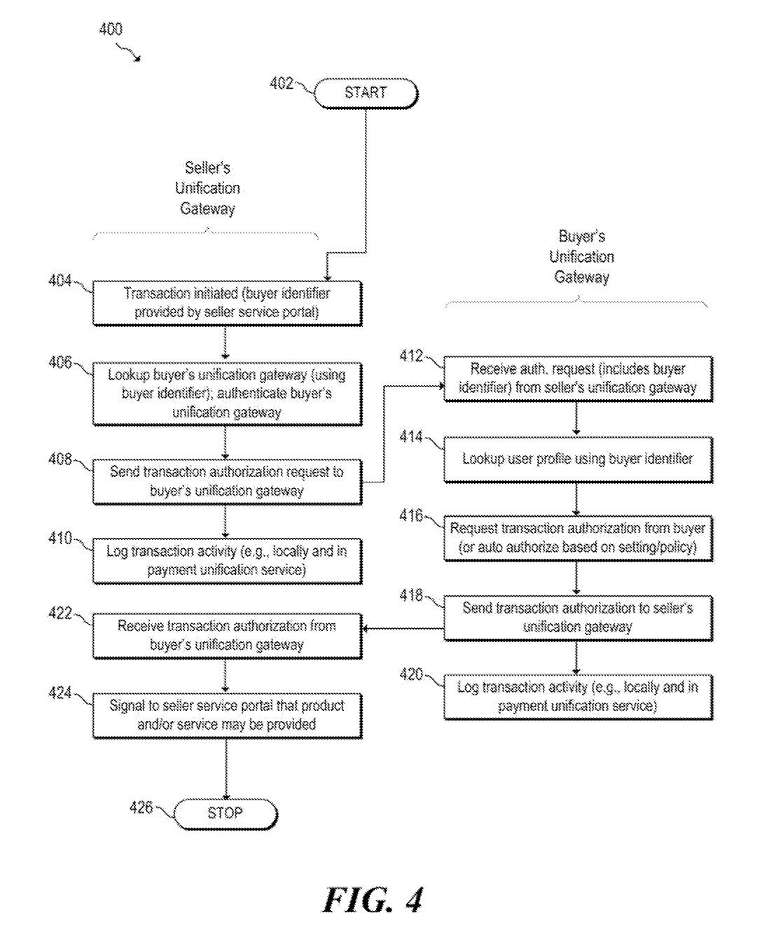

FIG. 4 depicts a flowchart of an example method 400 for a payment unification service. Various steps of method 400 may be executed in various places, for example, in the seller's payment service, in the seller's unification gateway, in the buyers payment service, in the buyer's unification gateway, and/or in the payment unification service. FIG. 4 generally breaks down the steps into steps executed in or near the seller's unification gateway on the left, and steps executed in or near the buyer's unification gateway on the right. It should be understood however that part or all of these steps may have components that are executed in the payment unification service. The steps of method 400 may be implemented in the form of executable instructions stored on at least one machine-readable storage medium. In addition or as an alternative, the steps of method 400 may be implemented using at least one hardware device that includes electronic circuitry for implementing the functionality described below. In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat.

Method 400 may start at step 402 and continue to step 404, where a transaction may be initiated in the seller's unification gateway (e.g., 302), for example, via a signal from the seller service portal (e.g., received/handled by interface 326 and module 308) that includes a buyer identifier. At step 406, the seller's unification gateway may communicate (e.g., via module 310) with the payment unification service to lookup the buyer's unification gateway. Once connection information is received for the buyer's unification gateway, the gateway may be authenticated by the seller's unification gateway (e.g., via module 312), for example, by checking the certificate. At step 408, the seller's unification gateway may send (e.g., via module 308) a transaction authorization request to the buyer's unification gateway. At step 410, the seller's unification gateway may log the transaction activity (e.g., locally and by communicating with the payment unification service). At step 412, the buyer's unification gateway (e.g., also generally represented by 302) may receive (e.g., via module 314) the authorization request (including the buyer identifier). At step 414, the buyer's unification gateway may look up (e.g., via module 304) the user profile associated with the buyer identifier. At step 416, the buyer unification gateway may authorize (e.g., via module 308) the transaction, for example, by requesting approval (e.g., via user interface 324) from the buyer or by automatic authorization (e.g., based on settings and/or policies). At step 418, the buyer's unification gateway may send (e.g., via module 314) the transaction authorization to the seller's unification gateway. At step 420, the buyer's unification gateway may log the transaction activity (e.g., locally and by communicating with the payment unification service). At step 422, the seller's unification gateway may receive (e.g., via module 314) the transaction authorization. At step 424, the seller's unification gateway may signal (e.g., via module 308 and interface 326) to the seller service portal that the product and/or service may be provided to the buyer. Method 400 may eventually continue to step 426, where method 400 may stop.

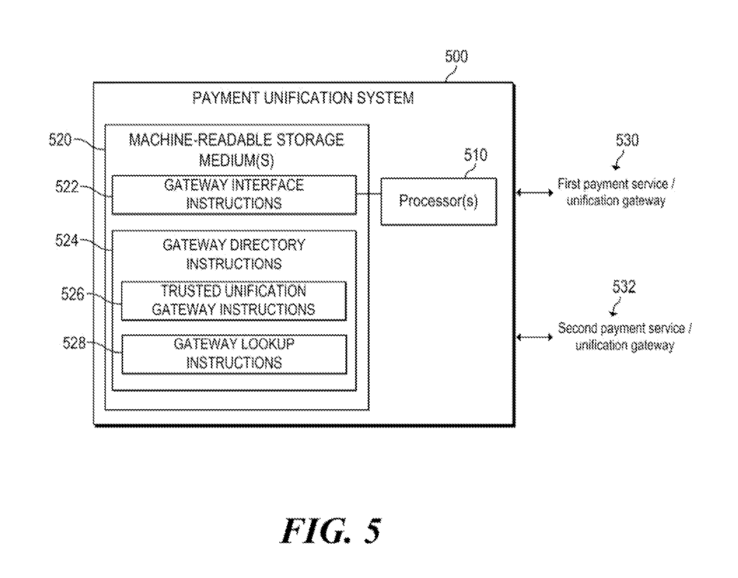

FIG. 5 is a block diagram of an example payment unification system. Payment unification system 500 may include at least one computing device that is accessible to users (e.g., buyers and/or sellers) over the Internet or some other network. In some embodiments, payment unification system 500 may include more than one computing device, in which case, multiple processors and/or machine readable mediums may be involved. More details regarding an example payment unification system and/or service may be described above, for example, with payment unification service 102 of FIG. 1. In the embodiment of FIG. 5, payment unification system includes at least one processor 510 and at least one machine-readable storage medium 520.

Processor(s) 510 may each be one or more central processing units (CPUs), CPU cores, microprocessors, and/or other hardware devices suitable for retrieval and execution of instructions stored in at least one machine-readable storage medium (e.g., 520). Processor(s) 510 may each fetch, decode, and execute instructions (e.g., instructions 522, 524, 526, 528) to, among other things, facilitate payment unification. With respect to the executable instruction representations (e.g., boxes) shown in FIG. 5, it should be understood that part or all of the executable instructions included within one box may, in alternate embodiments, be included in a different box shown in the figures or in a different box not shown.

Machine-readable storage medium(s) 520 may each be any electronic, magnetic, optical, or other physical storage device that stores executable instructions. Thus, machine-readable storage medium(s) 520 may each be, for example, Random Access Memory (RAM), an Electrically-Erasable Programmable Read-Only Memory (EEPROM), a storage drive, an optical disc, and the like. Machine-readable storage medium(s) 520 may each be disposed within a computing device. In this situation, the executable instructions may be “installed” on the computing device. Alternatively, machine-readable storage medium(s) 520 may each be a portable (e.g., external) storage medium, for example, that allows a computing device to remotely execute the instructions or download the instructions from the storage medium. In this situation, the executable instructions may be part of an installation package. As described below, machine-readable storage medium(s) 520 may each be encoded with executable instructions to facilitate payment unification.

Gateway interface instructions 522 may communicate with multiple unification gateways respectively associated with multiple payment services. Each unification gateway may allow the associated payment service to transact with other of the payment services via their associated unification gateways. Gateway directory instructions 524 may include trusted unification gateway instructions 526 and gateway lookup instructions 528. Trusted unification gateway instructions 526 may store a list of trusted unification gateways. Gateway lookup instructions 528 may receive a gateway lookup request from a first unification gateway associated with a first payment service when a transaction is to be initiated between the first payment service a second payment service via their associated unification gateways. Gateway lookup instructions 528 may further return gateway connection information to the first unification gateway in response to the gateway lookup requests to allow the transaction to proceed. The gateway connection information may indicate how to connect over a network with a second unification gateway associated with the second payment service.

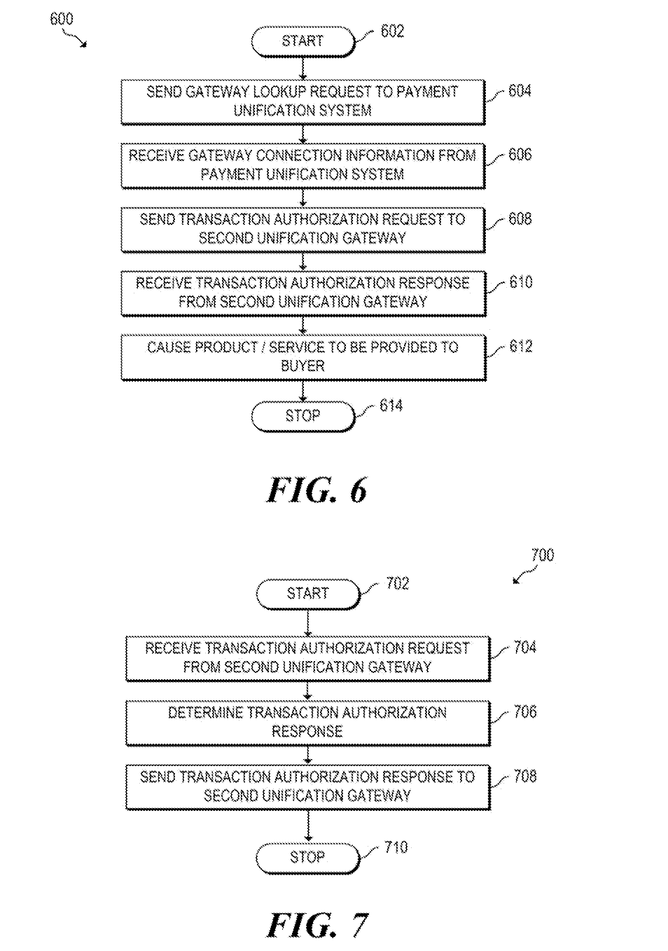

FIGS. 6 and 7 are flowcharts of example methods 600 and 700 for payment unification. Method 600 may be executed by a seller unification gateway, for example, first unification gateway 530 of FIG. 5 and/or unification gateway 120 of FIG. 1. Method 700 may be executed by a buyer unification gateway, for example, second unification gateway 532 of FIG. 5 and/or unification gateway 118 of FIG. 1. Methods 600 and 700 may each be implemented in the form of executable instructions stored on at least one machine-readable storage medium and/or in the form of electronic circuitry (e.g., as part of a payment service such as 104 or 106). In alternate embodiments of the present disclosure, one or more steps of method 600 and/or 700 may be executed substantially concurrently or in a different order than shown in FIGS. 6 and 7. In alternate embodiments of the present disclosure, method 600 and/or 700 may include more or less steps than are shown in FIGS. 6 and 7. In some embodiments, one or more of the steps of method 600 and/or 700 may, at certain times, be ongoing and/or may repeat.

Method 600 may start at step 602 and continue to step 604, where the seller's unification gateway may send a gateway lookup request to a payment unification system in response to a purchase request of a buyer. At step 606, the seller's unification gateway may receive gateway connection information from the payment unification system, wherein the gateway connection information indicates how to communicate with a second unification gateway associated with a payment service of the of the buyer. At step 608, the seller's unification gateway may send a transaction authorization request to the second unification gateway. At step 610, the seller's unification gateway may receive a transaction authorization response from the second unification gateway. At step 612, the seller's payment unification gateway may cause, in response to the transaction authorization response, a purchase process related to the purchase request of the buyer to proceed. Method 600 may eventually continue to step 614, where method 600 may stop.

Method 700 may start at step 702 and continue to step 704, where the buyer's unification gateway may receive a transaction authorization request from a second unification gateway associated with a payment service of a seller, in response to a purchase request of the buyer. At step 706, the buyer's unification gateway may determine a transaction authorization response based on input from the buyer via the payment service of the buyer, or based on a pre-authorization. At step 708, the buyer's unification gateway may send the transaction authorization response to the second unification gateway, thereby indicating that a purchase of the buyer related to the purchase request can proceed. Method 700 may eventually continue to step 710, where method 700 may stop.

It will be appreciated that the previous description of the disclosed examples is provided to enable any person skilled in the art to make or use the present disclosure. Various modifications to these examples will be readily apparent to those skilled in the art, and the general principles defined herein may be applied to other examples without departing from the spirit or scope of the disclosure. Thus, the present disclosure is not intended to be limited to the examples shown herein but is to be accorded the widest scope consistent with the principles and novel features disclosed herein.

1. A system for payment unification, the system comprising:
a gateway interface to communicate with multiple unification gateways respectively associated with multiple payment services, wherein each unification gateway allows the associated payment service to transact with other of the payment services via their associated unification gateways; and
a gateway directory to store a list of trusted unification gateways wherein the gateway directory is to:
receive a gateway lookup request from a first unification gateway associated with a first payment service when a transaction is to be initiated between the first payment service and a second payment service via their associated unification gateways; and
return gateway connection information to the first unification gateway in response to the gateway lookup requests to allow the transaction to proceed, wherein the gateway connection information indicates how to connect over a network with a second unification gateway associated with the second payment service.

2. The system of claim 1, wherein the gateway lookup request includes a user identifier provided by a user of the second payment service while the user submits a purchase request for a product or service via a seller service portal that is in communication with the first payment service.

3. The system of claim 2, wherein to return the gateway connection information, the gateway directory looks for gateway connection information that is associated with the user identifier.

4. The system of claim 1, further comprising a transaction aggregator to:
track transactions between the first unification gateway and the second unification gateway; and
cause the second unification gateway to transfer money to the first unification gateway only after multiple authorized transactions between the first and second gateway have completed.

5. The system of claim 1, further comprising a transaction log to record and store transaction information for transactions between the first unification gateway and the second unification gateway, wherein the transaction information does not include personal information of users involved in the transactions.

6. A method for payment unification executed by a first unification gateway associated with a payment service of a seller, the method comprising:
sending a gateway lookup request to a payment unification system in response to a purchase request of a buyer;
receiving gateway connection information from the payment unification system, wherein the gateway connection information indicates how to communicate with a second unification gateway associated with a payment service of the of the buyer;
sending a transaction authorization request to the second unification gateway; and
receiving a transaction authorization response from the second unification gateway, and in response, indicating that a purchase process related to the purchase request of the buyer can proceed.

7. The method of claim 6, further comprising authenticating the second unification gateway by using the gateway connection information and communicating with a certificate authority.

8. The method of claim 6, wherein the gateway lookup request includes a buyer identifier provided by the buyer as part of submitting the purchase request.

9. The method of claim 6, wherein the buyer is not registered with the payment service of the seller and the seller is not registered with the payment service of the buyer.

10. The method of claim 6, further comprising indicating that the seller should be paid via the payment service associated with the seller after the first unification gateway has received multiple transaction authorization responses on behalf of the seller.

11. A method for payment unification executed by a first unification gateway associated with a payment service of a buyer, the method comprising:
receiving a transaction authorization request from a second unification gateway associated with a payment service of a seller, in response to a purchase request of the buyer;
determining a transaction authorization response based on input from the buyer via the payment service of the buyer or based on a pre-authorization;
sending the transaction authorization response to the second unification gateway, thereby indicating that a purchase of the buyer related to the purchase request can proceed.

12. The method of claim 11, further comprising maintaining a buyer identifier for the buyer, wherein the buyer identifier is uniquely associated with an account of the buyer in the payment service of the buyer.

13. The method of claim 12, wherein the buyer identifier is temporary and changeable while still being uniquely associated with the account of the buyer.

14. The method of claim 11, wherein the buyer is not registered with the payment service of the seller and the seller is not registered with the payment service of the buyer, and thus the buyer cannot access personal or financial information of the seller, and the seller cannot access personal or financial information of the buyer.

15. The method of claim 6, further comprising indicating that the buyer should be billed via the payment service associated with the buyer after the first unification gateway has sent multiple transaction authorization responses on behalf of the buyer.
